(19) United States
(12) Patent Application Publication
(10) Pub. No.: US 2007/0237365 A1
(43) Pub. Date: Oct. 11, 2007

(54) Biometric identification

(76) Inventor: Donald M. Monro, Beckington (GB)

Correspondence Address: BERKELEY LAW & TECHNOLOGY GROUP, LLP, 17933 NW Evergreen Parkway, Suite 250, BEAVERTON, OR, 97006, US

(21) Appl. No.: 11/399,752

(22) Filed: Apr. 7, 2006

(51) Int. Cl. G06K 9/00

(52) U.S. Cl. 382/115

(57) ABSTRACT

Embodiments related to biometric identification are disclosed.

### FIELD

This application pertains to the field of biometric identification, and more particularly, to the field of identification based at least in part upon biometric detection of skull sutures.

### BACKGROUND

The field of biometrics may refer to methods of identifying and/or characterizing members of species by identifying a characteristic that may be different between all members of the species, as well as differentiating the members of the species based at least in part upon an identifiable characteristic.

### BRIEF DESCRIPTION OF THE DRAWINGS

The claimed subject matter will be understood more fully from the detailed description given below and from the accompanying drawings of embodiments, which should not be taken to limit the claimed subject matter to the specific embodiments described, but are for explanation and understanding only.

FIG. 1 is a block diagram of a system for biometric identification, according to an embodiment.

FIG. 2 is a diagram depicting a human skull, according to an embodiment.

FIG. 3 is a flow diagram of one embodiment of a method for biometric identification, according to an embodiment.

FIG. 4 is a block diagram of a computing platform capable of executing biometric identification in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Biometric information may be obtained by fingerprint and iris identification, as examples. Problems with fingerprint identification may include calluses and/or sanding of the finger, which may obscure the detection and identification based on fingerprints. Problems with iris identification may include positioning of the eye and obscuring of the eye by the eyelid and eyelashes.

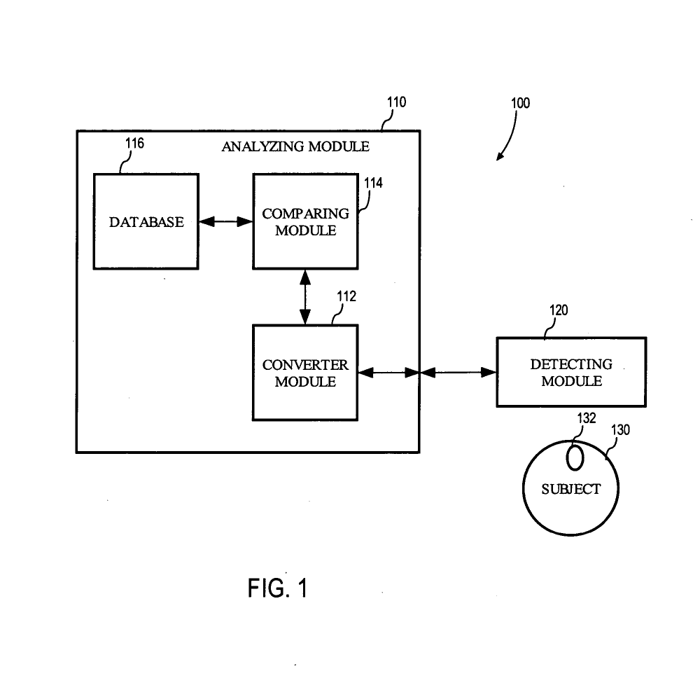

FIG. 1 is a block diagram of one embodiment of a system, which may be used for biometric identification, at 100. In an embodiment, system 100 may include an analyzing module 110. Analyzing module 110 may be coupled and/or in communication with a detecting module 120. Detecting module 120 may be capable of identifying a biometric identifier 132 from subject 130.

Subject 130 may be a mammal, such as, but not limited to, a human. Subject 130 may have a biometric identifier 132, which may be capable of detection by detecting module 120. Biometric identifier 132 may be skull sutures, or another biometric identifier, and/or combinations thereof. Skull sutures may be formed when the various plates of the skull grow together when the mammal is young. Skull sutures may be cartilage, and/or other material that may make it discernable from the bones of the skull. Skull sutures may be utilized as a biometric identifier because they may be somewhat random in their detail, and may be essentially unique to each individual and/or subject. Furthermore, skull sutures may not be easily obscured and/or altered to thwart identification.

Subject 130 may be a domesticated mammal such as a cow, horse, dog, etc. This biometric identification may be utilized to track meat animals for health reasons. Further, biometric identification may be utilized to identify show and/or race animals, such as dogs and horses, to insure identity and/or inhibit stealing and trafficking of stolen animals. Many other mammals and other subjects may be identified utilizing a biometric identifier.

Detecting module 120 may include magnetic resonance imaging (MRI), X-ray, infrared light, millimeter wave imaging, sound navigation and ranging (SONAR), radio detection and ranging (RADAR), and/or other detection methods, and/or combinations thereof. These methods may provide a non-invasive means for detecting biometric identifier 132. An MRI may provide differentiation between bone and cartilage.

Infrared light may penetrate the skin and may differentiate between different materials by reflection and/or absorption by the different materials. Infrared detection may be obtained by reflection and/or transmission, and/or combinations thereof. Shining an infrared light source from the side or below at a safe level may be utilized to reveal the sutures.

Millimeter wave imaging may include when light and/or radio waves may form a continuum known as the electromagnetic spectrum in which extremely high frequency waves merge into the relatively long wave infrared light. The transition region where the extremely high frequency waves merge into the relatively long wave infrared light may be where suitable millimeter and submillimeter wavelengths may be utilized for imaging. Millimeter wave imaging may be capable of penetrating clothing and may be quickly absorbed when it passes the skin barrier. Millimeter wave imaging may include tomographic and holographic imaging, among many others.

Skull sutures may be readily capable of being imaged as they lie a relatively short distance below the skin. Millimeter waves may pass through skin and clothing, but not metals. Sutures may be capable of being imaged by pausing briefly under to and/or next to a millimeter wave camera. With some processing images may be obtained safely, quickly, non-invasively, and relatively accurately.

Analyzing module 110 may include a converter module 112. Converter module 112 may be capable of receiving a signal from detecting module 120, and converting that received signal to data that may be saved, and/or utilized to compare to other saved data. Converter module 112 may also be capable of transmitting this data to comparing module 114.

Comparing module 114 may be capable of receiving data from converter module 112 and comparing that data to saved data from database 116. Data that may correspond to a representation of biometric identifier 132 may be compared to similar saved data to identify subject 130. If the data cannot be matched, the data may be saved in database 116 along with an identification of the subject that the data may correspond to. This may yield a relatively most likely subject, based at least in part upon the comparison of the data to data saved in an identifier database.

In an embodiment, biometric identifier 132 may be a skull suture, which may be captured as a structure in an image. The image may be a digitization of the image and/or the suture. Once digitized, the image and/or suture may be represented as a graph, and/or some function of position. In an embodiment, the representation may be a reference line, and the suture may be represented as a graph of distances from that reference line. In this embodiment, the suture may cross the reference line, which may represent zero crossings. Biometric identifier 132 may then be represented by the graph, zero crossings, and/or other characteristics of the graph, and/or suture, and/or combinations thereof.

Many characteristics of this graphing method may yield representations and/or other characteristic that may also for the biometric identifier 132 to be represented and/or described. This may include, but is not limited to, displacing the various values and measuring the sum of the squares of the differences. Further, number of zero crossings and/or distances between zero crossings, and/or combination thereof may be utilized. It is intended that this disclosure not be limited with this respect.

Another embodiment may include utilizing a series of short pieces of the suture and/or the graph, differencing them, and quantizing this difference along the graph to derive characteristic that may describe, at least in part, the biometric identifier 132. The transform may include, but is not limited to, Fourier, phase, frequency, frequency separation, discrete, discrete cosine, discrete wavelet, and/or other transforms, and/or combinations thereof. It will be appreciated that many transforms may be utilized to yield characteristic data, which may be utilized to identify a biometric identifier. It is intended that this disclosure not be limited with this respect.

Yet another embodiment may be to code the identifier at least in part by utilizing matching pursuits, and/or a code book to describe the biometric identifier 132. The codebook may include, but is not limited to, characteristic feature of skull suture and/or general waveform, among many others. It is intended that this disclosure not be limited with this respect.

Comparing the biometric identifier with a known identifier may include matching the two. This may involve utilizing a distance metric, such as but not limited to, measuring a distance between them, and/or measuring a distance between zero crossings, and/or Hamming distance, and/or other characteristics. It is intended that this disclosure not be limited with this respect.

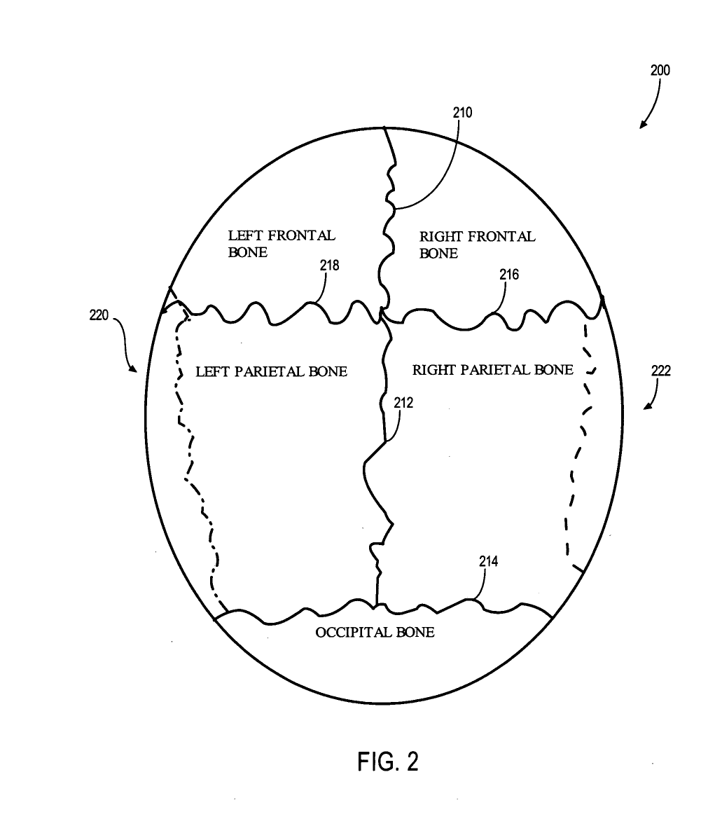

FIG. 2 shows a top view of a skull 200, according to an embodiment. Skull 200 may include a metopic suture 210, as well as sagittal suture 212, and lambdiod suture 214. Metopic suture 210 may be between the right and left frontal bone of skull 200. Sagittal suture 212 may lie between the right and left parietal bones. Lambdioid suture 214 may lie between the occipital bone and the right and left parietal bones.

Skull 200 may include right coronal suture 216 and left coronal suture 218. Skull 200 may also include left squamous suture 220 (hidden), and right squamous suture 222 (also hidden). Right coronal suture 216 may separate the right frontal bone and the right parietal bone. Left coronal suture 218 may separate the left frontal bone and the left parietal bone.

Metopic suture 210, sagittal suture 212, right coronal suture 216, and/or left coronal suture 218, and/or combinations thereof may be imaged from above and somewhat frontally. Similarly, lambdiod suture 214, left squamous suture 220, and/or right squamous suture 222, and/or combinations thereof may be imaged from the back and/or sides. Depending upon the application, different sutures, alone or in combinations may be imaged for identification purposes.

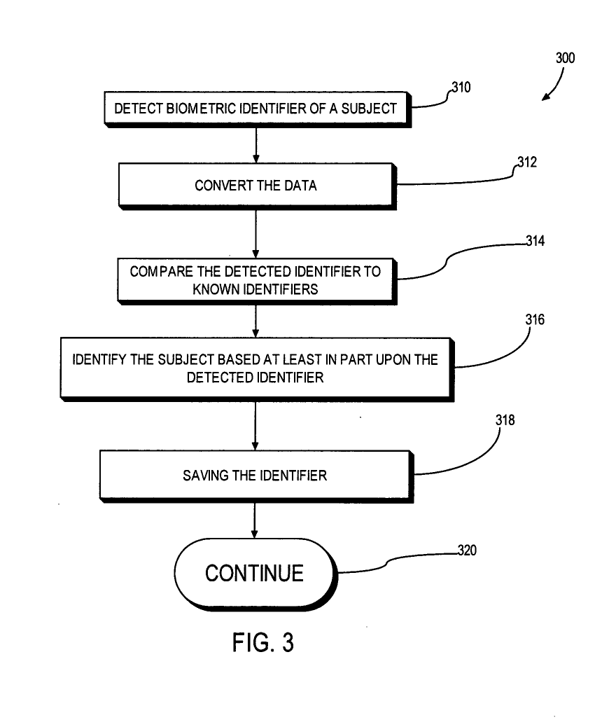

FIG. 3 is a flow diagram illustrating a method according to an embodiment, at 300. Method 300 may include detecting an identifier at 310. Biometric identifiers, which may include skull sutures, may be detected from a subject. Images of the sutures may then be converted to data at 312.

The data may be in a form that allows for comparing the detected identifier to known identifiers 316. The comparison of the detected identifier to known identifiers may lead to identifying the subject based at least in part upon the detected identifier 316. A biometric identification system and method may be utilized for identification of a subject from a large population (one to many matching). Furthermore, a biometric system and method may be utilized to confirm the subject is whom they claim to be (one to one matching). The method and system may also identify a most likely subject or a list of likely subjects. This determination may be based at least in part upon a predetermined percentage of portions of the identifier matching, among other determinations.

The detected identifier may be saved at 318. This may allow the identifier to be utilized in further comparisons with other known and/or detected identifiers, and/or combinations thereof. The method then continues at 320.

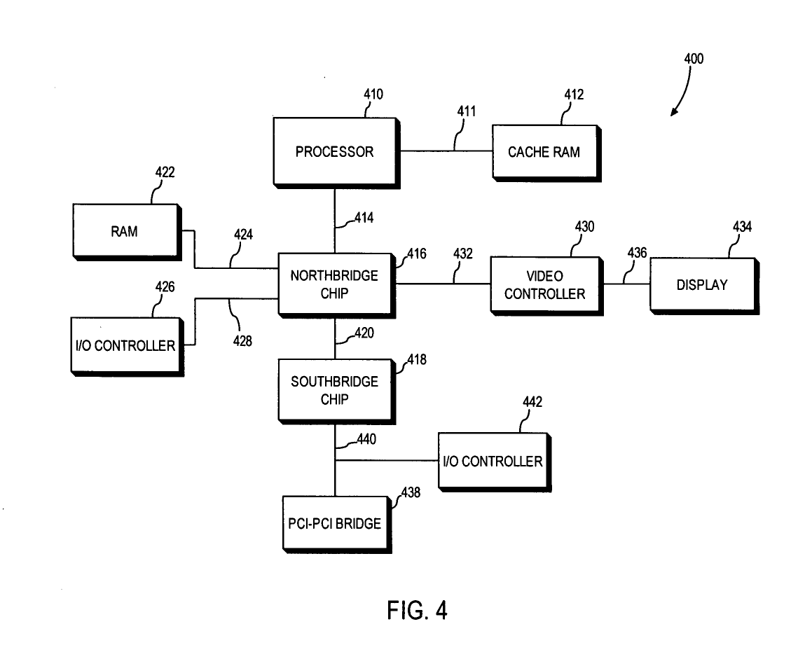

Referring now to FIG. 4, a block diagram of a computing platform capable of biometric identification in accordance with one or more embodiments will be discussed. It should be noted that computing platform 400 of FIG. 4 is merely one type of computing platform, and other computing platforms having more and/or fewer and/or different components than shown in FIG. 4 may be implemented, and the scope of claimed subject matter is not limited in this respect. In one or more embodiments, computing platform 400 may be utilized to implement process/method 300 in whole and/or using more and/or fewer blocks than shown in FIG. 4, and the scope of claimed subject matter is not limited in this respect. Computing platform 400 may include processor 410 coupled to cache random access memory (RAM) 412 via back side bus 411. Processor 410 may also couple to a chipset that includes Northbridge chip 416 via front side bus 414, and also to Southbridge chip 418 via bus 420. In one embodiment, Northbridge chip 416 in general may be utilized to connect a processor to memory, to an input/output bus, to a video bus, and to Level 2 cache, although the scope of claimed subject matter is not limited in this respect.

In one embodiment, Southbridge chip 418 may be utilized to control input/output functions, the basic input/out system (BIOS), and interrupt control functions of Integrated Drive Electronics (IDE) devices, such as hard disks or compact disk read-only memory (CD-ROM) devices or the like, although the scope of claimed subject matter is not limited in this respect. Random access memory (RAM) 422 may couple to Northbridge chip 416 via main memory bus 424, and input/output (I/O) controller 426 may also couple to Northbridge chip 416 via I/O bus 428. In one embodiment, I/O controller 426 and I/O bus 428 may be in compliance with a Small Computer Systems Interface (SCSI) specification such as the American National Standards Institute (ANSI) X3.131-1994 SCSI-2 specification, although the scope of claimed subject matter is not limited in this respect. In an alternative embodiment, I/O controller 426 and I/O bus 428 may be in compliance with a Peripheral Component Interconnect (PCI) bus, although the scope of claimed subject matter is not limited in this respect.

Video controller 430 may couple to Northbridge chip 416 via video bus 432, which in one embodiment may comprise an Accelerated Graphics Port (AGP) bus, although the scope of claimed subject matter is not limited in this respect. Video controller 430 may provide video signals to an optionally coupled display 434 via display interface 436, which in one embodiment may comprise a Digital Visual Interface (DVI) in compliance with a standard promulgated by the Digital Display Working Group, although the scope of claimed subject matter is not limited in this respect. Southbridge chip 418 may couple to a peripheral component interconnect to peripheral component interconnect (PCI-PCI) bridge 438 via input/output bus 440, which may in turn couple to I/O controller 442 to control various peripheral devices such as Universal Serial Bus (USB) devices, or devices compatible with an Institute of Electrical and Electronics Engineers (IEEE) 1394 specification, although the scope of claimed subject matter is not limited in this respect.

For example, some portions of the detailed description are presented in terms of processes, programs and/or symbolic representations of operations on data bits and/or binary digital signals within a computer memory. These processes, descriptions and/or representations may include techniques used in the data processing arts to convey the arrangement of a computer system and/or other information handling system to operate according to such programs, processes, and/or symbolic representations of operations.

A process may be generally considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It may be convenient at times, principally for reasons of common usage, to refer to these signals as bits, values, elements, symbols, characters, terms, numbers and/or the like. However, these and/or similar terms may be associated with the appropriate physical quantities, and are merely convenient labels applied to these quantities.

Unless specifically stated otherwise, as apparent from the following discussions, throughout the specification discussion utilizing terms such as processing, computing, calculating, determining, and/or the like, refer to the action and/or processes of a computing platform such as computer and/or computing system, and/or similar electronic computing device, that manipulate and/or transform data represented as physical, such as electronic, quantities within the registers and/or memories of the computer and/or computing system and/or similar electronic and/or computing device into other data similarly represented as physical quantities within the memories, registers and/or other such information storage, transmission and/or display devices of the computing system and/or other information handling system.

Embodiments claimed may include one or more apparatuses for performing the operations herein. Such an apparatus may be specially constructed for the desired purposes, or it may comprise a general purpose computing device selectively activated and/or reconfigured by a program stored in the device. Such a program may be stored on a storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and/or programmable read only memories (EEPROMs), flash memory, magnetic and/or optical cards, and/or any other type of media suitable for storing electronic instructions, and/or capable of being coupled to a system bus for a computing device, computing platform, and/or other information handling system. However, the computer program product may also be capable of being downloaded directly to the computing device, such as, but not limited to, a download over the Internet and/or other network and/or communication. This disclosure is intended to encompass a carrier wave format.

The processes and/or displays presented herein are not necessarily limited to any particular computing device and/or other apparatus. Various general purpose systems may be used with programs in accordance with the teachings herein, or a more specialized apparatus may be constructed to perform the desired method. The desired structure for a variety of these systems will appear from the description below. In addition, embodiments are not described with reference to any particular programming language. It will be appreciated that a variety of programming languages may be used to implement the teachings described herein.

In the description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments.

In the foregoing specification, claimed subject matter has been described with reference to specific example embodiments thereof. It will, however, be evident that various modifications and/or changes may be made thereto without departing from the broader spirit and/or scope of the subject matter as set forth in the appended claims. The specification and/or drawings are, accordingly, to be regarded in an illustrative rather than in a restrictive, sense.

What is claimed is:

1. A method, comprising:
detecting a biometric identifier; and
comparing the biometric identifier to known biometric identifiers;
wherein said detected biometric identifier comprises a skull suture.

2. The method according to claim 1, further comprising identifying a relatively most likely subject based at least in part upon a the comparison of the detected biometric identifier and a known biometric identifier.

3. The method according to claim 1, further comprising converting the detected biometric identifier to data capable of being stored and compared.

4. The method according to claim 3, further comprising storing the data.

5. The method according to claim 3, wherein the converting comprises selecting certain features of the skull sutures.

6. The method according to claim 3, wherein the converting comprises warping and aligning the data.

7. The method according to claim 3, wherein the converting comprises creating a graph based at least in part upon tracing a portion of a skull suture.

8. The method according to claim 7, wherein the comparing comprises comparing the graph to known graphs.

9. The method according to claim 7, wherein the comparing comprises comparing one or more features of the graph with known graphs.

10. The method according to claim 9, wherein the comparing of one or more features comprises comparing zero crossings of the graph.

11. The method according to claim 3, wherein the converting comprises transforming the data.

12. The method according to claim 11, wherein transforming the data produces characteristics that are utilized to compare the data.

13. The method according to claim 12, wherein said transforming comprises a frequency separating transform.

14. The method according to claim 11, wherein the transforming comprises a phase transform.

15. The method according to claim 11, wherein the transforming comprises a Fourier transform.

16. The method according to claim 11, wherein the transforming comprises a discrete transform.

17. The method according to claim 16, wherein the transforming comprises a discrete cosine transform.

18. The method according to claim 16, wherein the transforming comprises a discrete wavelet transform.

19. The method according to claim 3, wherein the converting comprises performing matching pursuits on the data.

20. The method according to claim 3, wherein the converting comprises utilizing a codebook to at least in part, define the data.

21. The method according to claim 3, wherein said comparing comprises utilizing a distance metric between the data and known data.

22. The method according to claim 2, wherein said relatively most likely subject comprises a mammal.

23. The method according to claim 2, wherein said relatively most likely subject comprises a human.

24. The method according to claim 2, wherein said relatively most likely subject comprises a domesticated animal.

25. The method according to claim 2, wherein said relatively most likely subject comprises a wild animal.

26. A computer program product capable of being stored on a computer readable medium comprising instructions that, if executed by a computing platform, result in biometric identification, by:
detecting a biometric identifier; and
comparing the biometric identifier to known biometric identifiers;
wherein said detected biometric identifier comprises a skull suture.

27. The product according to claim 26, further comprising identifying a relatively most likely subject based at least in part upon a the comparison of the detected biometric identifier and a known biometric identifier.

28. The product according to claim 26, further comprising converting the detected biometric identifier to data capable of being stored and compared.

29. The product according to claim 28, further comprising storing the data.

30. The product according to claim 29, wherein the converting comprises selecting certain characteristics of the skull sutures.

31. The product according to claim 30, wherein the converting comprises creating a graph based at least in part upon a tracing of a portion of a skull suture.

32. The product according to claim 31, wherein the comparing comprises comparing one or more features of the graph with known graphs.

33. The product according to claim 32, wherein the comparing of one or more features comprises comparing zero crossings of the graph.

34. The product according to claim 28, wherein the converting comprises transforming the data.

35. The product according to claim 34, wherein transforming the data produces characteristics that are utilized to compare the data.

36. The product according to claim 34, wherein said transforming comprises a frequency separating transform.

37. The product according to claim 34, wherein the transforming comprises a phase transform.

38. The product according to claim 34, wherein the transforming comprises a Fourier transform.

39. The method according to claim 34, wherein the transforming comprises a discrete transform.

40. The product according to claim 39, wherein the transforming comprises a discrete cosine transform.

41. The product according to claim 39, wherein the transforming comprises a discrete wavelet transform.

42. The product according to claim 28, wherein the converting comprises performing matching pursuits on the data.

43. The product according to claim 28, wherein the converting comprises utilizing a codebook to at least in part, define the data.

44. The product according to claim 28, wherein said comparing comprises utilizing a distance metric between the data and known data.

45. A system for enhancing data, comprising:
means for detecting a biometric identifier; and
means for comparing the biometric identifier to known biometric identifiers;
wherein said detected biometric identifier comprises a skull suture.

46. The system according to claim 45, further comprising means for identifying a relatively most likely subject based at least in part upon a the comparison of the detected biometric identifier and a known biometric identifier.

47. The system according to claim 45, further comprising means for converting the detected biometric identifier to data capable of being stored and compared.

48. The system according to claim 47, further comprising means for storing the data.

49. The system according to claim 47, further comprising means for transforming the biometric identifier or the data to yield characteristics that are capable of being utilized for comparing.
